(19) United States
(12) Patent Application Publication
(10) Pub. No.: US 2008/0156467 A1
(43) Pub. Date: Jul. 3, 2008

(54) Folded Heat Exchanger

(76) Inventor: Johannes Antonius Maria Reinders, Warnsveld (NL)

Correspondence Address: HOWREY LLP, C/O IP DOCKETING DEPARTMENT, 2941 FAIRVIEW PARK DR., SUITE 200, FALLS CHURCH, VA, 22042, US

(21) Appl. No.: 11/658,174

(22) PCT Filed: Jul. 21, 2005
(86) PCT No.: PCT/EP05/08062

§ 371 Date: Jan. 23, 2007

(30) Foreign Application Priority Data
Jul. 23, 2004 (GB) 041645.1

(51) Int. Cl. F28D 1/04; B21D 53/02; F02M 31/00

(52) U.S. Cl. 165/151; 29/890.03; 261/153

(57) ABSTRACT

The invention relates to a jet-weaving machine, particularly an air jet-weaving machine, which comprises a main discharge nozzle (1) with a mixing tube (2) for introducing a weft thread (3) into a shed by means of a conveying fluid discharged from the main discharge nozzle (1), and comprises a clamping device. This clamping device is placed inside the mixing tube (2) in the area from which the weft thread exits, and is provided with an actuator, which is situated outside of the mixing tube (2) and with a lever that is connected thereto in such a manner that this lever, when actuating the actuator (6) via an actuating means or when the actuation is stopped, executes a tilting motion whereby clamping the weft thread in an opening of the mixing tube between itself and an abutment (9).

The present invention relates to a heat exchange unit and a method of manufacture of such a heat exchange unit in particular for use in heat exchange between two fluid flows in an evaporative type heat exchanger.

Heat exchangers for heat exchange between two fluid streams are generally known in which a dividing wall separates the two fluid streams. In general, it is an objective of many such devices to increase the surface area of the dividing wall to increase the effective heat transfer between the two fluids. Generally, the wall will be thin to maximise the thermal gradient and in such cases, the conductivity of the wall material is not critical if its total area is sufficiently large. A device is known from EP0777094, which uses a sheet folded in layers to produce a heat exchange element for heat recovery purposes. The sheet is formed of Japanese paper or the like and may be formed with ribs to ensure spacing of the layers.

It is also known to produce evaporative cooling devices comprising a number of primary and secondary fluid channels in heat exchanging contact with one another. By wetting the surface of the secondary fluid channels, evaporation of liquid into the secondary fluid causes cooling of the primary fluid. A dew point cooler is a particular form of evaporative heat exchanger, which attempts to bring down the temperature of a product air stream to as close to the dew point temperature as possible. To achieve this, the secondary fluid is pre-cooled, preferably by branching off a portion of the primary air, and absorbs moisture as it warms back up to the inlet temperature. Such a process is theoretically extremely efficient and requires no compressor, as is the case for conventional refrigeration cycles. Many attempts have been made to realise such cycles but practical considerations have caused great difficulties in approaching the dew point over most temperature ranges.

A device is known from WO03/091633 A, the content of which is hereby incorporated by reference in its entirety, which has been found extremely effective at approaching the dew point. The device comprises a number of channels formed as heat transmitting membranes. The channels are provided with heat conducting protrusions that extend from the membranes into the channels and serve to conduct heat between membrane and fluid. The fins may be at least partially covered with a water retaining layer. One of the key features of that invention is the connection between the protrusions or fins and the membrane. This connection must ensure adequate heat transfer through the membrane to a corresponding fin on the opposite side.

The process of forming individual channels, each provided with fins on both surfaces has been found to be time consuming and expensive involving a considerable number of components and steps. Present manufacturing techniques require rows of fins to be individually stuck to both sides of a plate like membrane. A pair of such plates are then bonded together to form a channel and a batch of channels (usually 10) are then assembled in a block to form a heat exchange unit for use in a dew point cooler.

According to the present invention there is provided a heat exchange unit comprising a membrane provided with heat conducting protrusions on both surfaces thereof, the membrane is folded in concertina like fashion to form a plurality of primary and secondary fluid channels thermally connected to one another by the membrane. The heat conducting protrusions may be in the form of fins and may further be provided with other surface area increasing elements or elements for breaking up the boundary layers of the fluids used. Such elements may take the form of louvres or openings in the fins. According to a particularly advantage of the invention, by providing protrusions on both the first and second surfaces of the membrane, the protrusions on the first surface support against those on the second surface and enhance the mechanical rigidity of the folded heat exchange element. This is a particular advantage of the construction which allows the use of extremely thin gauge material. A further consequence of the use of thin gauge material is that heat transfer in the plane of the membrane is small compared to heat transfer therethrough, making possible the use of metal or other relatively conductive materials.

Advantageously the heat conducting protrusions on a first surface of the membrane extend finer than the heat conducting protrusions on a second surface, whereby the primary channels are wider than the secondary channels.

According to a preferred form of the invention, the heat exchange unit may further comprise a water-retaining layer provided on surfaces of at least the secondary fluid channels. In this way the unit may be operated as a dew point cooler. Preferably, at least protrusions in the secondary channels are provided with such water retaining layer. The primary channels may thus serve as dry flow channels and the secondary channels may form the wet flow channels.

According to a further feature of the invention, the heat exchange element may be located inside a housing or package. This package may be a solid structure or merely a flexible wrap serving to generally surround the folded membrane and hold it together. The package may also serve to separate the individual primary and secondary channels by sealing or otherwise closing over the tops and bottoms of the folds. In most cases, sealing or complete separation of adjacent primary channels or adjacent secondary channels is not necessary as they may carry the same fluid. In such cases it may be sufficient to provide a seal only at the beginning and end of the folded membrane to prevent flow between the primary and secondary channels.

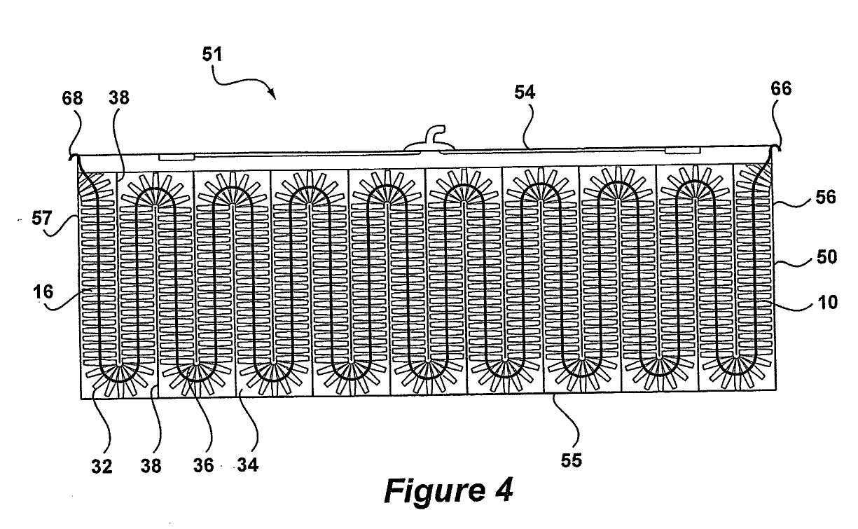

In a preferred form of the invention, the housing is provided with at least one inlet to the primary channels, at least one outlet from the secondary channels and at least one outlet from the primary channels. It has been discovered that in order to optimise design flexibility and reduce production costs, the housing should be provided with a number of selectively enabled inlet and outlet apertures. These apertures can then be used as and when required. The heat exchange element including the housing may then be manufactured as a standard unit for insertion into different designs of heating, cooling or ventilation devices. According to the device, different apertures will be enabled. The apertures may thus initially be closed by e.g. frangible covers, flaps, plugs or the like. Alternatively the apertures may initially be open and may be closed by blank portions of the: devices into which the unit is inserted. Such a housing construction is clearly not limited to containing continuous folded heat-exchangers as described above but could also be used for containing individual flow channels such as described and shown in FIG. 4 of WO03/091633 A.

In order to further improve versatility, the heat exchange unit may also comprise selectively enabled flow bypass portions e.g. providing connection between channels. The flow bypass portions are preferably arranged within the housing and ay take the form of frangible or otherwise openable partitions. Alternatively, frangible or openable regions of the membrane may be provided for communication e.g. between the primary and secondary surfaces thereof. Such an arrangement is particularly suitable for use as a dewpoint cooler, where the outlet from the primary channels can then communicate with an inlet to the secondary channels.

According to a further advantageous embodiment, the housing is provided with a valve for selectively enabling flow between the primary and secondary channels. Known dew point coolers are provided with such a valve to control the relative distribution between the primary air supplied as a product and the portion which returns through the secondary channels. This valve can be provided within the housing whereby the external device need only be provided with connecting elements for actuation thereof.

A preferred material for manufacture of the heat exchange element is thin gauge soft annealed aluminium. Such material has been found ideal for deep drawing and cold forming of the various elements. In particular, by forming both the membrane and the protrusions from such material, ease of connection is achieved while ensuring good heat conduction between the protrusions on opposite surfaces of the membrane.

Preferably, the heat conducting protrusions are adhered to the membrane e.g. in a continuous process. It has been found that by using a laminate provided with a heat-seal layer for either the membrane or the protrusions, these components may be easily joined by heat and pressure. Depending upon the nature and intended use of the heat exchange unit, the laminate may further comprise additional layers. A layer of primer or the like may be required between a metal layer and a heat-seal layer to improve bonding or to provide protection against corrosion Such primer may also be pigmented or otherwise coloured to improve the aesthetic effect or to optimise heat transfer. Furthermore, for use as an evaporative heat exchanger, humidifier or for improved wicking, a water-retaining or water-transporting layer may be provided over some or all of the surfaces of the laminate. This layer may be adhered by means of the heat-seal layer or otherwise.

According to a further aspect of the present invention there is also provided a method of manufacturing a heat exchange unit, comprising: providing a deformable, heat-conducting conducting first membrane; providing a deformable second membrane having first and second surfaces; plastically forming the first membrane into a series of protrusions; connecting the first membrane to the second membrane to form a heat transmitting wall with heat-conducting protrusions on both surfaces thereof; and folding the second laminate in a concertina like fashion to form a series of primary and secondary flow channels. In this way, a heat exchange unit comprising a number of primary and secondary channels may be produced from only two components.

The method may further comprise the step of dividing the first membrane into sections prior to connecting it to the second membrane. It has been found that individual fin sections separate from one another can prevent heat conduction along the heat exchanger and can also help to encourage turbulent flow by breaking up the boundary layer. This may also be achieved or improved by forming louvres or conduction bridges in the first membrane prior to connecting it to the second membrane.

Preferably, the first and second membranes are connected together by sealing under heat and pressure. This may be achieved by providing at least the first or the second membrane with a heat-sealable layer. The heat-sealable layer may be provided as a laminate or may be introduced between the first and second membranes on joining.

According to a particular advantage of the invention, the method allows the first and second membranes to be connected together in a substantially continuous process. Furthermore, the folding of the heat exchange element may also take place continuously, with the heat exchange element then cut into blocks of e.g. 20 folds for separate packaging into a heat exchange unit.

Advantageously according to the method, the first membrane also comprises first and second surfaces, the first surface being provided with a water retaining layer and the second surface being connected to the second membrane. The heat exchange unit produced in this way may ideally be used in a dew point cooler, for humidifying dry air or in a heat recovery device.

The protrusions on both surfaces of the second membrane may be formed from the first membrane. Alternatively, a third membrane may be provided and plastically formed into a series of protrusions for connection to the second membrane such that the first membrane is connected to the first surface and the third membrane is connected to the second surface. The third membrane may be substantially similar to the first membrane or may be different, particularly if the properties of the primary and secondary flow channels are to be distinct.

According to an important feature of the invention, the protrusions formed on one surface of the membrane may be distinct from those on the opposing side both in shape and material. In particular, the protrusions may be different in height. Since the height of the protrusion can determine the width of the flow channel, the relative widths of the primary and secondary channels can hereby be distinguished. This is especially useful for dewpoint coolers where only part of the primary air is returned through the secondary channels.

Embodiments of the invention will now be described by way of example only with reference to the drawings, in which:

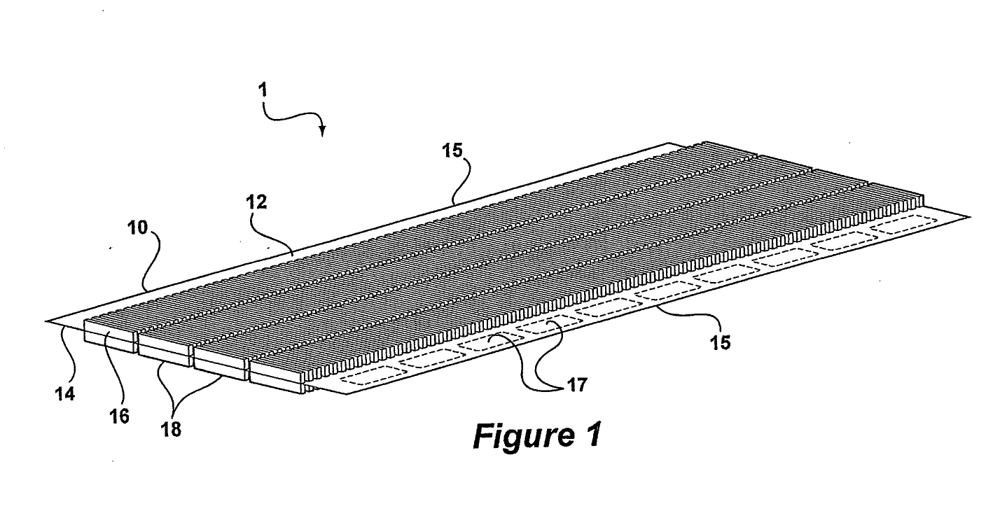

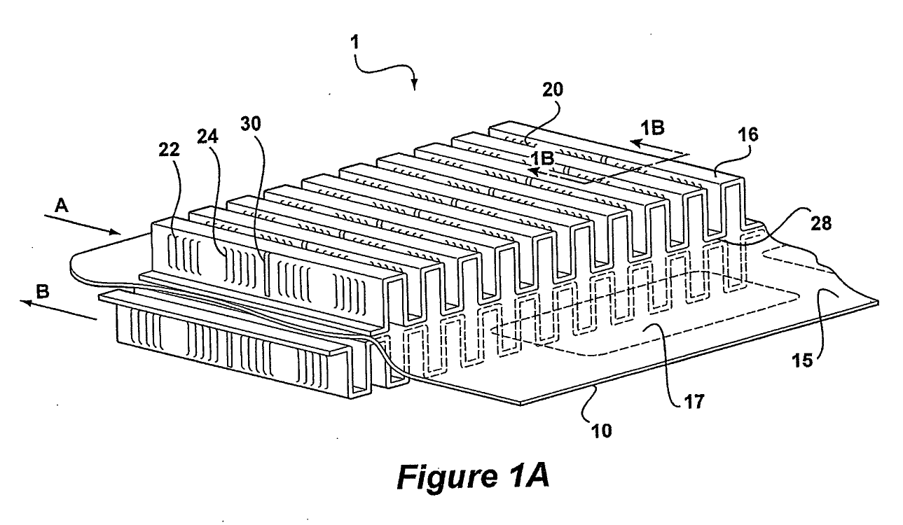

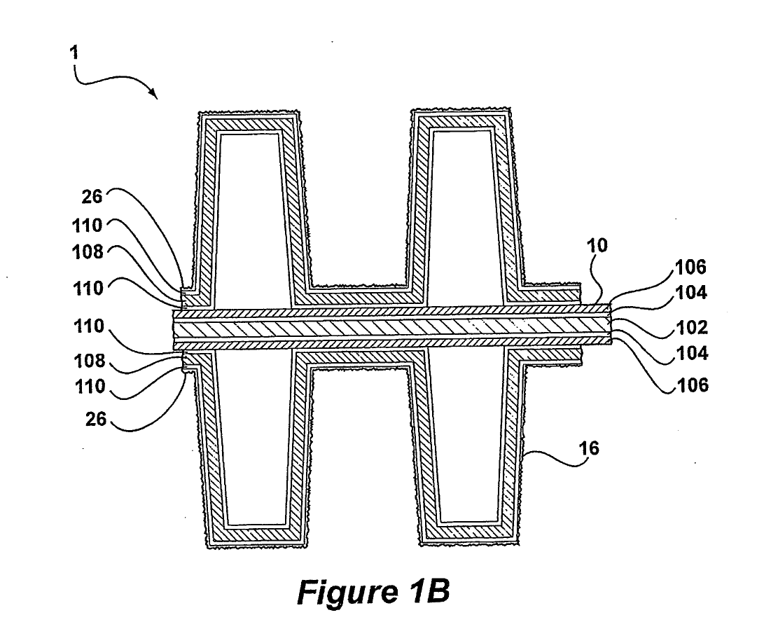

FIG. 1 shows a perspective view of a heat exchange element according to the present invention prior to folding;

FIG. 1a shows an enlarged detail of the heat exchange element of FIG. 1;

FIG. 1b shows a partial cross section through the heat exchange element of FIG. 1a along line 1-1;

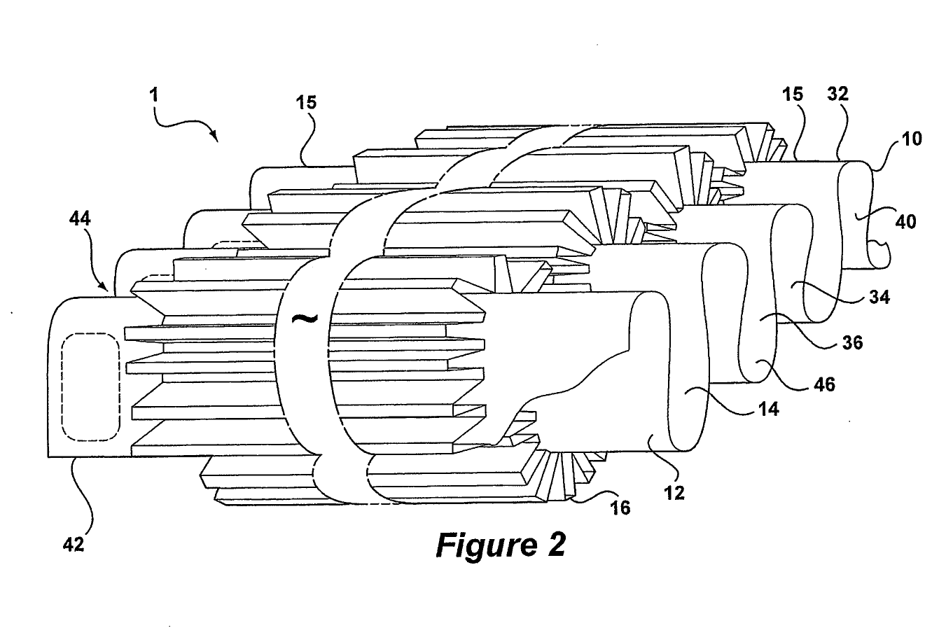

FIG. 2 shows a perspective view of part of the heat exchange element of FIG. 1 in a folded configuration;

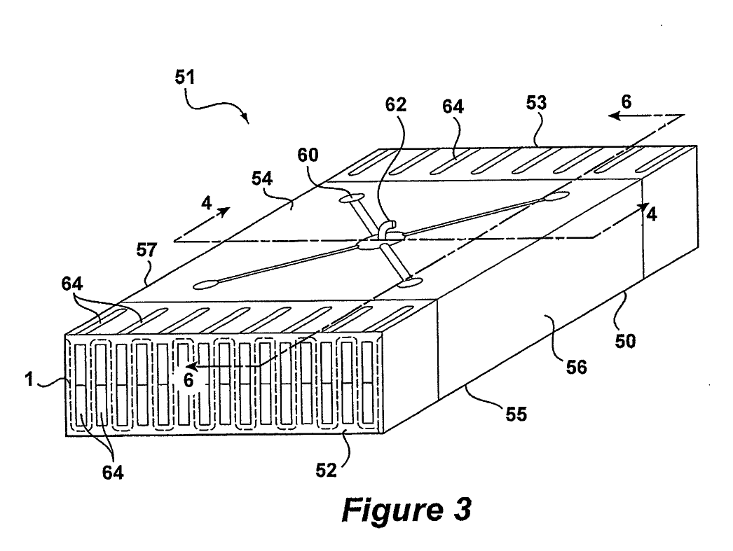

FIG. 3 shows a perspective view of a heat exchange unit containing a folded section of the heat exchange element of FIG. 1;

FIG. 4 shows a cross-section through the unit of FIG. 3 taken along line 4-4;

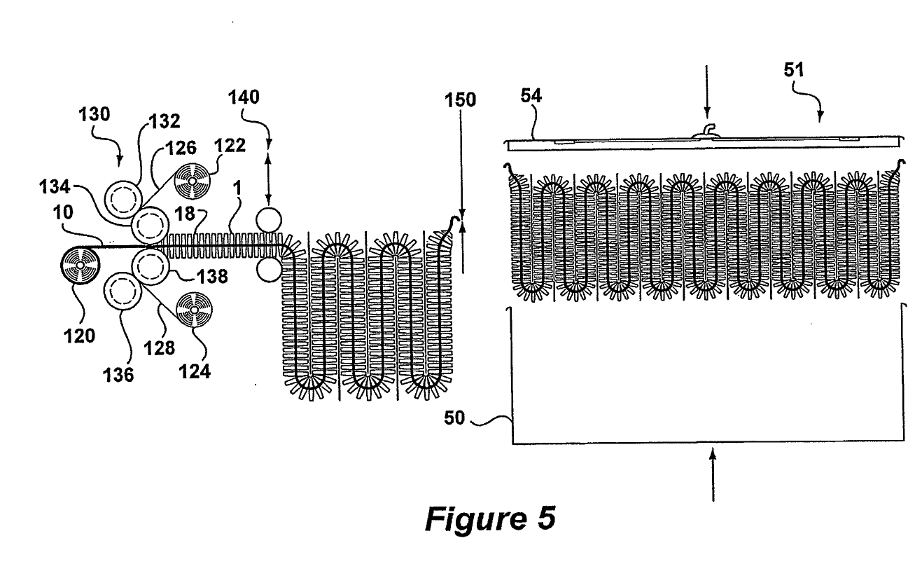

FIG. 5 shows a method of manufacturing a heat exchanger according to the invention; and

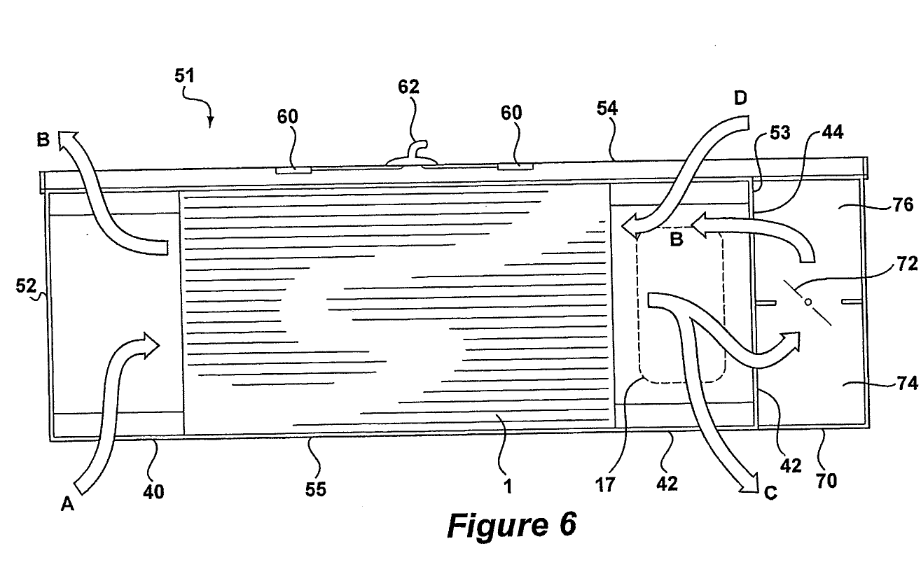

FIG. 6 shows a longitudinal section through the unit of FIG. 3, taken along line 6-6.

FIG. 1 shows a section of a heat exchange element 1 according to the present invention in an unfolded state. The heat exchange element 1 comprises a membrane 10 having a first surface 12 and a second surface 14. The membrane 10 is formed from a thin gauge metal sheet for instance copper or aluminium. Both sides of the membrane 10 are provided with fins 16 arranged in strips 18. The strips 18 may be affixed to the membrane 10 in any appropriate way but it has been found particularly advantageous to use heat seal adhesive. To this end, the fins 16 are formed from a metal such as aluminium, laminated with a heat seal adhesive. Although metal has been found preferable for manufacture of the membrane 10 and fins 16 it is noted that other materials including plastics materials may be used as described in prior applications WO 03/091648 A and WO 01/57461 A, the contents of which are hereby incorporated by reference in their entirety. In this respect, heat transmission between the fins 16 on the first surface 12 and the second surface 14 should be ensured by appropriate joining techniques or by heat transfer members. Edge regions 15 of the membrane 10 are maintained free of fins 16 for use as inlet and outlet elements. Frangible regions 17 are also provided on the membrane. These features will be described in further detail below.

The construction of the heat exchange element 1 is shown in further detail in FIG. 1a which shows a cut-away section of part of the construction. Arrows A and B give an indication of the direction of air flows in use e.g. as a dewpoint cooler. The fins 16 are provided with louvres 20 in the form of elongate slots penetrating through the laminate. The louvres 20 are arranged in groups. A first group 22 serves to direct flow into the surface, while a second group 24 directs flow out of the surface. In this way, air can be caused to alternately flows over the first surface, where it can receive moisture by evaporation from a liquid retaining layer (to be described below), followed by the second surface where it can receive direct thermal energy to raise its temperature.

In addition to their function in directing flow between the surfaces of the fins 16, louvres 20 also serve to break up the boundary layers that may develop as air flows along the surfaces. Other break up elements may be provided in addition or instead of the louvres 20. Furthermore, while the fins 16 of FIG. 1 are straight, curvilinear or zig-zag fins may also be produced. It is believed that such fin shapes are advantageous in breaking up the boundary layers that develop in flow along the fins, since each time the fin changes direction, turbulent flow is re-established. Various cross-sectional shapes are also possible for the fins, including corrugations of square, trapezoidal, rectangular, bell and sine wave shapes. In particular, it is noted that the base or trough 28 of the fin should preferably be as flat as possible with sharp corners in order to maximise the area of heat transfer to the membrane 10.

In addition to louvres 20, fins 16 are provided with conduction bridges 30. These bridges 30 are in the form of cuts through the fin 16 over substantially its whole height They serve to prevent unwanted transport of heat along the fins 16 in the direction of the air flow.

FIG. 1b shows the different layers forming the construction. The membrane 10 comprises a base layer of soft annealed aluminium 102, layers of primer 104 applied thereto and anti-corrosive adhesive layer 106 applied thereover, activated by heat and pressure for coupling of the fins 16. The fins 16 also comprise a layer of soft annealed aluminium 108 provided with layers of primer 110. The fins are also provided with a liquid retaining layer 26 on their outer surface.

The liquid retaining layer 26 is formed from a fibrous material. Although reference is made to a liquid retaining layer, it is clearly understood that the layer is in fact a liquid retaining and releasing layer. The layer 26 is schematically illustrated to have a very open structure such that the metal laminate of the fin 16 can be clearly seen through the spaces between the fibres of the layer 26. An exemplary material for forming the water retaining layer is a 20 g/m2 polyester/viscose 50/50 blend, available from Lantor B. V. in The Netherlands. Another exemplary material is a 30 g/m2 polyamide coated polyester fibre available under the name Colback™ from Colbond N. V. in The Netherlands. Other materials having similar properties including synthetic and natural fibres such as wool may also be used. Where necessary, the liquid retaining layer may be coated or otherwise treated to provide anti bacterial or other anti fouling properties.

The liquid retaining layer 26 may be adhesively attached to the metal layer over the entire area of the strips 18. For use with aluminium and Lantor fibres as mentioned above, a 2 micron layer of two-component polyurethane adhesive has been found to provide excellent results. When present as such a thin layer, its effect on heat transfer is negligible. Such fibrous layers have been found ideal for the purposes of manufacturing since they can be provided as a laminate that can be formed into fins and other shapes in a continuous process. Other liquid retaining layers such as Portland cement may also be used and have in fact been found to provide superior properties although as yet, their production is more complex since there is a tendency to crack or flake if applied prior to forming of the heat exchange element.

FIG. 2 shows a heat exchange element 1 according to the present invention in its folded configuration. The element 1 has been folded in the form of a single concertina in a series of bends 32. Bends 32 effectively form the membrane 10 into a series of primary 34 and secondary 36 channels, alternately located on the first surface 12 and second surface 14 of the membrane. The primary channels 34 are open along their lower edges while the secondary channels 36 are open along their upper edges. The channels 34, 36 are maintained open by the fins 16 which rest against one another and serve to space the folds of the membrane 10. Loose shims 38 (see FIG. 4) may be optionally inserted into channels 34, 36 to improve the support between the fins 16 and may also serve for liquid distribution purposes.

The edge regions 15 extend beyond the fins 16 to form primary inlets 40, primary outlets 42, secondary inlets 44 and secondary outlets 46 to the respective primary 34 and secondary 36 channels.

FIG. 3 shows a perspective view of a housing 50 containing a folded heat exchange element 1 similar to that of FIG. 2, forming a heat exchange unit 51. The housing 50 has a front 52, back 53, top 54, bottom 55 and sides 56, 57 and generally surrounds the heat exchange element 1 on all sides. The position of one end of the heat exchange element 1 within the housing 50 is indicated by a broken line. The housing is formed of mouldable plastics material for ease of construction. Other materials may however be used including metal, composites and shrink wrap films.

The top 54 is provided with a number of water distribution nozzles 60 of the rotary spray type, connected to a water supply spigot 62 which may be connected up to a suitable source of water for wetting the secondary surfaces when used as a dew point cooler. The housing 50 is also provided with a number of frangible elements 64 on the front 52, top 54 and bottom 55 (not shown). The frangible elements are initially closed, but can be selectively opened to provide access to the primary inlets 40, primary outlets 42, secondary inlets 44 and secondary outlets 46 according to the required use of the heat exchange unit 51. This arrangement ensures considerable versatility whereby a single standard unit 51 may be arranged in different heating cooling and ventilation devices provided with different inlet and outlet configurations. Such a housing construction may also be used with other heat exchange elements such as non-folded or tubular constructions of the heat exchange element 1.

FIG. 4 depicts a cross section through heat exchange unit 51 along line 4-4 of FIG. 3 illustrating the folded heat exchange member 1. As can be seen from the figure, top 54 serves to generally close off the upper edges of the secondary channels 36 and the bottom 55 closes off the lower edges of the primary channels 34. In the disclosed embodiment, the housing 50 does not completely seal the channels from one another and adjacent primary channels 34 may communicate with one another to a limited degree, as may the secondary channels 36. If such communication is not desired, e.g. if different fluids are to be provided in different primary channels, some or all of the channels may be separated completely by appropriate sealing arrangements between the folds and the housing. Because of the malleable nature of the fins 16 and the membrane 10, the fins 16 may be easily crushed in the area of the bends 32 allowing the membrane 10 to assume the desired shape. Furthermore, a leading edge 66 and trailing edge 68 of the heat exchange element may be captured and crushed between the top 54 and the sides 56, 57 to ensure sealing between the primary 34 and secondary 36 channels. FIG. 4 also shows loose shims 38 inserted between abutting fins 16.

FIG. 5 shows schematically the manufacture of a heat exchanger according to the present invention. Membrane 10 is supplied from a continuous roll 120. Two further rolls 122, 124 provide upper and lower webs 126, 128 of material to form the fin strips 18. The rolls 122, 124 each carry four axially separate windings of material for the separate strips 18. It is however also within the scope of the invention that a full width web be provided and separated into strips during the forming of the fins. Alternatively, a separate roll may be provided for each strip 18.

The membrane 10 and the webs 126, 128 are fed to a crimping station 130. The crimping station 130 comprises a pair of toothed rollers 132, 134 for the upper web and a similar pair of toothed rollers 136, 138 for the lower web. The teeth of the rollers 132, 134 engage with one another to crimp the web 126 into the required fin shape as the web 126 is fed between them. A similar action is performed on the web 128 by the rollers 136, 138. Soft annealed aluminium is particularly adapted to such cold drawing and can be easily formed into different shapes at considerable speed. The louvres 20 and conduction bridges 30 may be formed by the same rollers 132, 134, 136, 138 or may be incorporated in a separate step.

Rollers 134 and 138 are arranged to abut one another without engagement of their teeth. They are also heated to a temperature suitable for sealing the adhesive layer 106. Membrane 10 and crimped webs 126, 128 are fed between the rollers 134, 138 and heat-sealed together to produce a continuous output of heat exchange element 1.

The output from the crimping section 130 is fed to a folding section 140 which folds the heat exchange element 1 into a series of folds. The folded heat exchange element 1 is then cut at 150 after every 19 folds whereby a total of nine primary channels 34 and ten secondary channels 36 are formed. Clearly, other numbers of folds may also be used. Loose shims 38 may be inserted between the folds at this point. The cut section is then placed into housing 50 and top 54 applied to form a heat exchange unit 51.

FIG. 6 depicts a longitudinal section through heat exchange unit 51 along line 6-6 of FIG. 3, further provided with a valve unit 70 for use as a dew point cooler. The primary inlets 40 are formed by removing frangible elements 64 on the bottom 55 adjacent the front 52. Secondary outlets are formed in a similar way by removing frangible elements 64 from the top 54 adjacent to the front 52. Valve unit 70 comprises a generally hollow interior and contains a valve 72 which divides the interior into a lower volume 74 and an upper volume 76. The valve unit is fitted to the back face 53 of the housing 50 and includes elements (not shown) that serve to open further frangible elements 64 in the back face 53 to form primary outlets 42 into the lower volume 74 and secondary inlets 44 communicating with the upper volume 76. Additional frangible elements 64 are removed from the bottom 55 adjacent to the back face to provide an additional primary outlet 42.

Operation of the heat exchange unit 51 as a dew point cooler will now be described with reference to FIGS. 2, 3, 4 and 6. A flow of air A to be cooled enters the housing 50 via the primary inlet 40 and passes through primary channels 34 of the heat exchange element 1 where it is cooled by heat transfer to the fins 16 and membrane 10. A portion of the air is delivered as product air C to the space where cooling is desired. The remainder of the air (approximately one third) passes into the lower volume 74 and via valve 72 to upper volume 76. It then returns as a secondary air flow B via secondary inlet 44 and secondary channels 36 in heat exchange element 1 to secondary outlet 46 where it exits the housing 50 and may return e.g. to the environment Water is supplied via water supply spigot 62 to distribution nozzles 60 for wetting the secondary surfaces As the secondary air B passes through the secondary channels 36, it absorbs moisture by evaporation from the liquid retaining layer 26 and thereby extract heat from the membrane 10 and the fins 16 in the secondary channels 36.

The use of a valve 72 provides the possibility of regulating the relative amounts of product C and secondary flow B. Alternatively, the heat exchange unit 51 can be operated without the valve unit 70 by opening the frangible regions 17 to provide direct communication between the outlets of the primary channels 34 and the inlets of the secondary channels 36.

FIG. 6 also indicates the versatility of the heat exchange unit 51 for use in providing heat recovery e.g. for winter-time use. By opening frangible elements 64 in the top face 54 adjacent to the back face 53, a flow-of return air D can be directed into the secondary channels 36. If valve 72 is closed (or otherwise not used), the return air D exiting from a building or similar space can exchange heat with the incoming air A.

While the above examples illustrate preferred embodiments of the present invention it is noted that various other arrangements may also be considered which fall within the spirit and scope of the present invention as defined by the appended claims.

1. A heat exchange unit comprising a membrane provided with heat conducting protrusions on both surfaces thereof, the membrane being folded in concertina like fashion to form a plurality of primary and secondary fluid channels thermally connected to one another through the membrane.

2. The heat exchange unit according to claim 1, further comprising a water-retaining layer provided on surfaces of at least the secondary fluid channels.

3. The heat exchange unit according to claim 1, further comprising a housing generally surrounding the folded membrane and serving to separate at least the primary and secondary channels.

4. The heat exchange unit according to claim 3 wherein the housing is provided with at least one inlet to the primary channels, at least one outlet from the secondary channels and at least one outlet from the primary channels.

5. The heat exchange unit according to claim 3, wherein the housing is provided with a number of selectively enabled inlet and outlet apertures.

6. The heat exchange unit according to claim 1 further comprising a flow bypass connecting an outlet from the primary channels to communicate with an inlet to the secondary channels.

7. The heat exchange unit according to claim 3, wherein the housing is provided with a valve for selectively enabling flow between the primary and secondary channels.

8. The heat exchange unit according to claim 1, wherein the membrane comprises soft annealed aluminium.

9. The heat exchange unit according to claim 1, wherein the heat conducting protrusions are adhered to the membrane by heat and pressure.

10. (canceled)

11. The method according to claim 20, wherein at least the first and third membranes, or the second membrane comprises a heat-sealable layer and the first and third membranes are connected to the second membrane by sealing under heat and pressure.

12. The method according to claim 20, wherein the first and third membranes are connected to the second membrane in a continuous process.

13. The method according to claim 20, wherein at least one of the first third membranes comprises first and second faces, the first face being provided with a water retaining layer and the second face being connected to the second membrane.

14. (canceled)

15. The method according to claim 20, wherein the third membrane is different from the first membrane.

16. The method according to claim 20, further comprising the step of forming louvres in at least one of the first or third membranes prior to connecting it to the second membrane.

17. A dew point cooler comprising a heat exchange unit according to claim 1.

18. A method of manufacturing a dew point cooler according to claim 20.

19. A heat exchange unit comprising a housing containing primary and secondary flow channels in heat conducting relation to one another, the housing being provided with a plurality of selectively enabled flow apertures for providing respective inlets and outlets to the respective primary and secondary flow channels.

20. A method of manufacturing a heat exchange unit, comprising:
providing a deformable, heat conducting first membrane;
providing a deformable second membrane having first and second surfaces;
providing a deformable, heat conducting third membrane;
plastically forming the first membrane into a series of protrusions;
plastically forming the third membrane into a series of protrusions;
connecting the first and third membrane to the first and second surface of the second membrane to form a heat transmitting wall wherein the first membrane is connected the first surface and the third membrane is connected to the second surface; and
folding the second membrane in a concerting like fashion to form a series of primary and secondary flow channels.
